(19) United States
(12) Patent Application Publication
(10) Pub. No.: US 2009/0230368 A1
(43) Pub. Date: Sep. 17, 2009

(54) ADAPTABLE BEAM LIFTER ELEMENT (ABLE) SYSTEM

(75) Inventors: Adam C. Marsh, Forest Lake, MN (US); John S. Perry, Afton, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: BAE SYSTEMS LAND & ARMAMENTS L.P., Arlington, VA (US)

(21) Appl. No.: 12/404,926

(22) Filed: Mar. 16, 2009

Related U.S. Application Data
(60) Provisional application No. 61/036,729, filed on Mar. 14, 2008.

(51) Int. Cl. B60S 9/22

(52) U.S. Cl. 254/35

(57) ABSTRACT

The present invention is an Adaptable Beam Lifter Element (ABLE) system for use in lifting and moving an assortment of military vehicles and containers in transit and storage. An ABLE device is generally a structure having a low-profile frame that contains hydraulic lift, maneuvering, and drive features that may readily be placed beneath or around vehicles or containers for desired movement in a confined space. By using ABLE devices, transported vehicles placed on ships or in other confined locations can be stowed very close together, while allowing vehicles to be retrieved easily and efficiently, without dedicating a vast amount of space for maneuvering. In some embodiments, multiple ABLEs may be ganged and slaved logically together to form a system to cooperatively lift and transport a variety of vehicles and containers including many types of military equipment.

### RELATED APPLICATION

The present application claims the benefit of U.S. Provisional Application No. 61/036,729 filed Mar. 14, 2008, entitled “ADAPTABLE BEAM LIFTER ELEMENT (ABLE) SYSTEM,” which is incorporated by reference herein in its entirety.

### FIELD OF THE INVENTION

The present invention relates to an apparatus for lifting and transporting a wide variety of vehicles and containers including trailers and military equipment. The ABLE system further includes a method of slaving a master unit with at least one slave unit for lifting and maneuvering large objects from a first location to a second location.

### BACKGROUND OF THE INVENTION

The transport of military vehicles and containers from a storage location to a theater of operation is a difficult logistical issue involving the optimal use of space aboard the heavy transport. Whether the heavy transport is a ship or a plane, the movement of these large military objects and supply containers requires the ability to closely pack the objects while maintaining the ability to rearrange the objects quickly based on demand. For example, while in transit from a stateside base to a foreign location a need may develop for certain stores or vehicles that was unexpected. Thus it would be beneficial to be able to reconfigure the load in transit for quicker access upon reaching the destination. Loading, unloading or transferring containers or vehicles are generally carried out by cranes or other lifting devices, wherein the containers are lifted from the side or from the top, depending on the corresponding standard. However, such equipment is usually somewhat limited and the location fixed. Therefore, there is a need to load the objects onto an intermediary style loading device that allows for closely placing the objects during loading and allowing for efficient retrieval.

### SUMMARY OF THE INVENTION

The present invention is an Adaptable Beam Lifter Element (ABLE) system for use in lifting and moving an assortment of military vehicles and containers in transit and storage. An ABLE devices is generally a structure having a low-profile frame that contains hydraulic lift, maneuvering, and drive features that may readily be placed beneath or around vehicles or containers for desired movement in a confined space. By using ABLE devices, transported vehicles placed on ships or in other confined locations can be stowed very close together, while allowing vehicles to be retrieved easily and efficiently, without dedicating a vast amount of space for maneuvering. In some embodiments, multiple ABLEs may be ganged and slaved logically together to form a system to cooperatively lift and transport a variety of vehicles and containers including many types of military equipment.

In an embodiment of the invention, an adaptable beam lifter element device for lifting and maneuvering vehicles and containers comprises a frame including a first elongate support portion and a second elongate support portion coupled adjacent one another in slideable relation. The device includes a hybrid electric drive system disposed within the frame, the hybrid electric drive system including an engine coupled to a generator for charging a plurality of batteries and supported by the frame. The device also includes an electric hydraulic assembly powered by the generator. The electric hydraulic assembly includes a pump, a valve network, a plurality of telescopic lift cylinders, and a plurality of drive motors. Also included in the device is a controller for controlling operation of the engine, the power source, and the electric hydraulic assembly. The frame includes a plurality of omni-directional drive devices located at spaced-apart locations on the frame. Each of the omni-directional drive devices are equipped with a telescopic lift cylinder. Each of the lift and omni-directional drive devices are also equipped with a pair of the drive motors operably connected to a plurality of wheel units, where the wheel units are arranged in a split castor configuration.

In another embodiment of the invention, an adaptable beam lifter element device for lifting and maneuvering vehicles and containers comprises a frame member having an upper face adapted to selectively interface with vehicles and containers of various shapes and dimensions. The device also has a plurality of wheeled units. The wheeled units are disposed within the frame member and include a hydraulically actuated lift cylinder and a pair of hydraulic common drive motors capable of omni-directional maneuvering and drive. The lift cylinder positioned between a wheel set and the upper face of the frame member. The device also has a secondary lift device supported by the frame member comprising a beam member coupled to a hydraulic lift cylinder. The secondary lift device arranged so that the beam member extends vertically from the upper face of the frame member. Additionally, a hydraulic beam arm is pivotaly attached at a first end to the frame member. The beam member extending horizontally from the frame member. In addition to these components, the device has an electric-over-hydraulic system for providing control and hydraulic power for the plurality of wheeled units, the secondary lift device, and the beam arm.

In further embodiments of the invention, an adaptable beam lifting system includes a master beam lifting unit comprising an adjustable frame. The frame includes a hydraulically actuated lifting means and a hydraulically actuated drive means controlled by a electric hydraulic system. The system includes a slave beam lifting unit comprising an adjustable frame. The slave frame includes a hydraulically actuated lifting means and a hydraulically actuated drive means controlled by a electric hydraulic system. The slave beam lifting unit is logically coupled to the master unit such that when operator input is made to the master unit, the slave unit reads the master unit for parameters including speed, pivot location, and lift heights.

Further embodiments of the invention include a method of lifting and transporting vehicles and containers. The method includes providing a plurality of adaptable beam lifting element units including a master unit and one or more slave units, each of the adaptable beam lifting element units carrying out independent drive, lift and maneuvering. The method further includes positioning the master unit to a defined position aligned to engage a load consisting of a vehicle or container. Next, the master unit mode is set to park, and the slave units are positioned one at a time to a position for engaging the load. The slave unit mode is subsequently set to synchronize. Commands are communicated to the master unit which cause the slave units to read the master unit for speed, pivot locations and lift heights. The loads are then lifted and maneuvered using both the slave and master units cooperatively as initialed by the operator, where commands from the operator are only directly communicated to the master unit. The master unit thereafter causing cooperative movement instructions to be given to the slave units via a communications link between the master and the slave units.

### BRIEF DESCRIPTION OF THE DRAWINGS

FIG. 1a is a perspective view of a self-contained lifting unit referred to as an ABLE device according to an embodiment of the invention.

FIGS. 1b and 1c are perspective views of alternate configurations for the ABLE device according to an embodiment of the invention.

FIG. 1d is a top view of an ABLE device according to an embodiment of the invention.

FIG. 1e is a side elevational view of an ABLE device according to an embodiment of the invention.

FIG. 1f is a front elevational view of an ABLE device according to an embodiment of the invention.

FIGS. 2a and 2b respectively, are perspective views of an ISO (International Organization for Standardization) beam adapter and a plurality of ISO beam adapters mounted to ABLE devices side loaded on an ISO container according to an embodiment of the invention.

FIG. 2c is a goose neck adapter for an ABLE device according to an embodiment of the invention.

FIG. 2d is an example of fork tines used as an adapter to an ABLE device according to an embodiment of the invention.

FIG. 3 is a perspective views of ABLE devices end loaded on a MTVR (Medium Tactical Vehicle Replacement) according to an embodiment of the invention.

FIG. 4 is a partial perspective view of the lower half of an LMD (Lifting Maneuver Drive) device according to an embodiment of the invention.

FIG. 5 is a partial perspective view of an LMD device according to an embodiment of the invention.

FIG. 5a is a cross-sectional view of an LMD device according to an embodiment of the invention.

FIG. 6a is a perspective view for and ABLE device having the SLD and LMD devices both in an extended configuration according to an embodiment of the invention.

FIG. 6b is a perspective view for and ABLE device having the SLD in the extended configuration and the LMD devices in a non-extended configuration according to an embodiment of the invention.

FIG. 7 shows a frame beam for an ABLE device according to an embodiment of the invention.

FIG. 8a is a perspective view of an ABLE device end-loaded on a HMMWV (High-Mobility Multipurpose Wheeled Vehicle) according to an embodiment of the invention.

FIG. 8b is a perspective view of an ABLE device side-loaded on a HMMWV according to an embodiment of the invention.

FIG. 8c is a perspective view of ABLE devices end-loaded on a LVSR (Logistics Vehicle System Replacement) according to an embodiment of the invention.

FIG. 8d is a perspective view of ABLE devices side-loaded on a LVSR according to an embodiment of the invention.

FIG. 9 is a perspective view of the quick release shackle system on an ABLE device according to an embodiment of the invention.

FIG. 10 sets forth the components of the hybrid electrical system of an ABLE device according to an embodiment of the invention.

FIG. 11 is a schematic diagram of the hydraulic system of an ABLE device according to an embodiment of the invention.

FIG. 12 is a flow chart demonstrating an example of steps performed to logically gang and slave multiple ABLE devices to form a system according to an embodiment of the invention.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

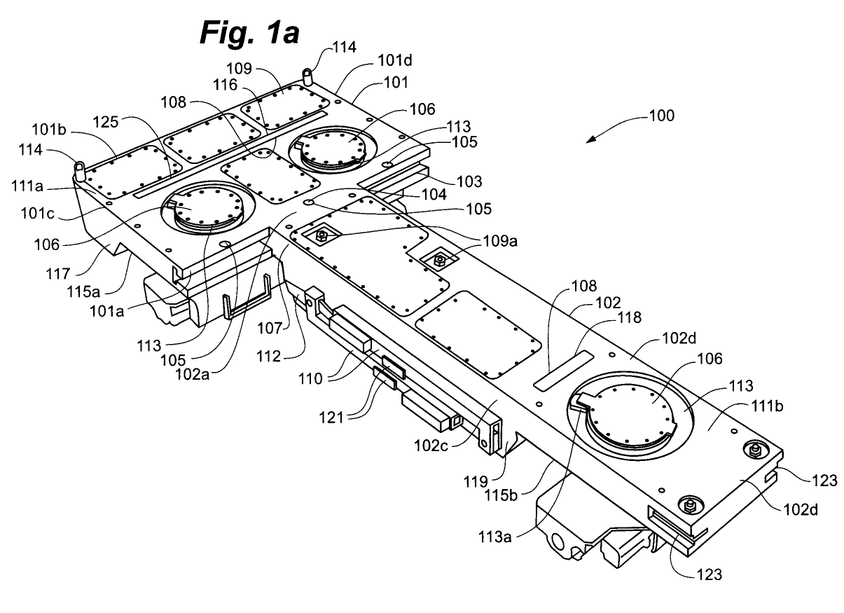

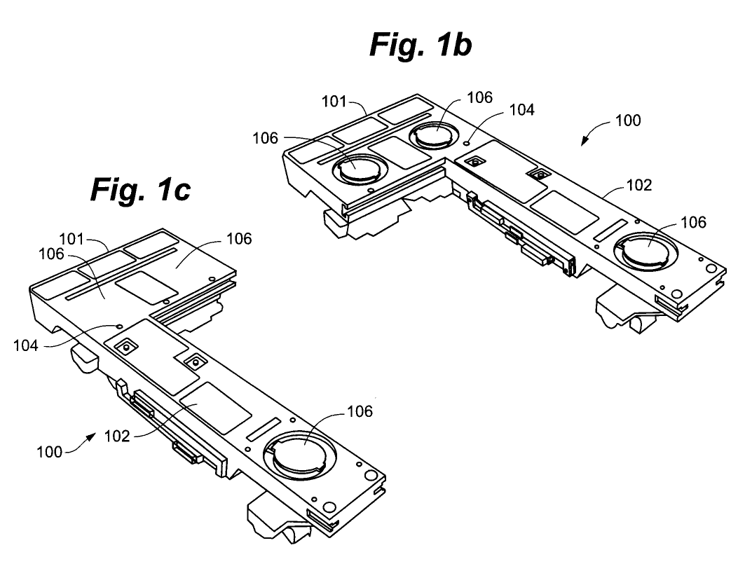

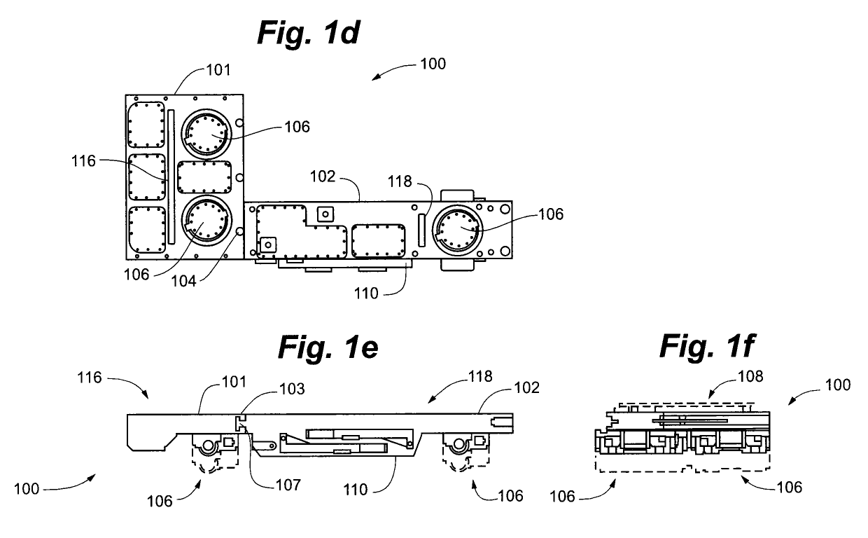

In its various embodiments, the ABLE system a self-contained, operator controlled, lifting device which is able to accomplish desired lifting and maneuvering capabilities through use of one or more ABLE devices 100. An embodiment of a general ABLE device 100 is shown in FIG. 1a. As shown, the frame of the device is generally comprised of a head portion 101 and a beam portion 102. In FIG. 1a, these portions are slideably connected via a flange structure 107 protruding from the beam portion 102 which is retained within a grooved feature 103 on the head portion 101. In the configuration of FIG. 1a, the beam portion 102 is locked into place with a pin 104 placed through one of the aperatures 105 located at the center position of the head portion 104 so as to form a “T” shape.

Embodiments and views of an ABLE device are seen in FIGS. 1a-f setting forth various components of the ABLE device. One of these components includes a plurality of Lift Maneuver Drive (LMD) devices 106 capable of causing cooperative but independent lift of the head portion 101 and beam portion 102 of the frame structure to which they are engaged as well as motorized steering and drive capabilities at the instruction of a user. Other components of the ABLE devices 100 include hydraulically powered secondary lift devices 108 which provide additional lifting capabilities to an operator, a plurality of selectively attachable, hydraulically controlled frame beams 110 that can be configured as supplemental support arms for certain applications, a kickstand 112 for holding the ABLE device 100 in place during reconfiguration procedures, and a plurality of quick release shackles 114 that are useful for stability and support when needed in transport or otherwise. Together these and other components cooperate to form a device allowing for efficient, selective, and safe movement and stowage of vehicles and containers in space restrictive environments such as ships.

First, with respect to the overall structure of the device, the head portion 101 of the ABLE device constitutes an elongate, generally rectangular-shaped platform which is supported by a plurality of wheels and structure extending from the LMD devices 106. As shown, the two LMD devices 106 are located in spaced-apart relation in the head portion 101. The top surface 111a of the head portion 101 is generally flat and provides a planar platform of material for engaging a vehicle or container when a lifting operation is carried out. Releasable shackles 114 are found at each of the two outward facing comers of the head. An elongated rectangular recess 116 extends lengthwise across the surface of the head 101 providing access to the SLD 108 housed below the top surface 111a. Additionally, circular recessed areas 113 are found on the head surface 111a. These recessed areas 113 each surround LMD devices 106 which extend through and below the platform structure of the head portion 101. Access to the LMD components is made easier by these recessed portions 113 if maintenance or repair of these units is required. Tabs 113a are found extending across the recessed portions 113 which provide an inlet housing surrounding a tapped hydraulic connection for each of the respective lift cylinders 140 of the LMDs 106. Additionally, access panels 109 are spaced throughout the surface of the ABLE device to provide openings for maintenance and assembly. Similarly, caps 109a and 109b provide access to hydraulic tank and fuel tanks located within the device frame. The four-sided rectangular head portion 101 has two longer sides 101a and 101b and two shorter sides 101c and 101d. Side 101a is adjacent the coupled beam portion 102 and 101b is on the opposite side furthest from the beam portion 102.

The bottom surface 115a of the head portion 101 contains a head housing compartment 117 located adjacent side 101b. The head housing compartment 117 includes the batteries, system controller, valve blocks 161, SLD 108. The bottom surface 115a of the platform is narrower and more recessed at the area adjacent the side 101a. This provides additional clearance for the LMD devices 106 to engage and operate beneath the frame and is sized for free pivoting of the wheels. Side 101a of the head portion 101 contains a grooved feature 103 for engaging the beam portion 102. This grooved feature 103 has an upper and lower lip which help retain a T-shaped flange feature 107 of the beam portion 102. At the top surface 111a, along edge 101a adjacent the beam member, are a plurality of aperture locations 105 for insertion of a pin 104. This pin 104 is for manually locking the beam member 102 into place with respect to the head portion 101. Although the device will typically be locked into place via operation of the hydraulic motor drives, the manual lock of pin 104 provides additional structure to achieve the desired alignment of the selected configuration.

The beam portion 102 of the frame is an elongate rectangular platform of material oriented adjacent the head portion 101 such that its length extends perpendicular to the length of the head portion 101. The four-sided rectangular shaped beam portion has two sides 102a and 102b of short length and sides 102c and 102d of longer length. Side 102a is located adjacent the head portion 101 and side 102b is located opposite the head portion 101. The top surface 111b of the beam section is generally planar and includes a short rectangular recess 118 for housing the secondary lift device 108 below the surface as well as a generally circular recess 113 surrounding the LMD 106 located near side 102b and opposite the side 102a. The SLD recess 118 provides an access passage for the SLD to function and raise above the beam top surface 111b when desired. Likewise, the recess 113 surrounding the LMD 106 provides space for accessing the LMD 106 for maintenance and repairs.

The bottom face 115b of the beam portion 102 contains a kickstand 112 adjacent side 102a at the end of the beam 102. This kickstand 112 can be deployed either manually or automatically when the ABLE device is lifted with the LMD devices 106. The kickstand 112 functions to help hold the beam portion 102 of the ABLE device in place when the geometry of the ABLE device 101 is modified with respect to the slideably coupled location of the head 101 and beam 102 portions. The bottom face 115b of the beam portion 102 contains a beam housing compartment 119 adjacent the kickstand 112 that extends more than half the length of the beam member 102. The beam housing compartment 119 of the frame contains various components of the electric hydraulic system including an engine 154, alternator 156, inverter 162, fuel tank, hydraulic reservoir and SLD 108. The remaining area of bottom face 115b of the beam 102 has a recessed portion extending adjacent to side 102b. This recessed section allows for more clearance and space in which one of the LMD devices 106 can operate.

The lengthwise sides 102c and 102d of beam 102 also are equipped with features that may be used in operation of the ABLE device 100. First, near the center of side 102 are mounts 121 to which frame beams 110 can be engaged and stored when these compartments are not in use. At the corners of the lengthwise sides adjacent side 102b are receptacles 123 in which the frame beams 110 may be selectively mounted. These frame beams 110 may be hydraulically manipulated to suit the desired lift points of a vehicle and the proper vehicle height. These frame beams 110 thereby are often capable of providing useful structural support members for lifting smaller vehicles and containers.

The ABLE devices 100 are configurable in geometry to adapt to varying wheel bases or container widths. One way in which the geometry of the device 100 is modified is by unlocking the beam portion 102 including raising the LMD devices 106, manually releasing pin 104, lowering the kickstand 112, lowering the LMD devices 106 on the head portion 101, and driving the head portion 101 into place with the LMD devices 106 and relocking. The beam portion 102 may generally be locked into place at the center position or when one of the short sides of the head portion 101 is aligned with a lengthwise side of the beam portion 102 along one edge and an aperture 105 for receiving a pin 104 is properly aligned. This provides for a ABLE device having a “L” shape or backwards “L” shape in addition to the “T” shape of FIG. 1a, as seen in FIGS. 1b and 1c, respectively.

Lifting, locomotion, and maneuverability of a given load is achieved with the LMD devices 106. The LMD devices 106 allow for the full 360-degree maneuverability and the physical lifting of the vehicles or containers. Locomotion, pivoting, and lifting may be produced by a servo-controlled AC-powered electric-over-hydraulic system. These features comprising some aspects of the electric hydraulic system of the device. The LMD devices 106 will be described later in greater detail.

A Secondary Lift Device (SLD) 108 adapts to varying clearances between ground and the undercarriages or frames. In the embodiments shown in FIGS. 1a-f, 6a, and 6b the SLD 108 contains a first SLD member 125 on the head portion 101 of the ABLE device 100 and a second SLD member 127 on the beam portion 102 of the ABLE device 100. The SLD 108 has beams 129 supported by hydraulic actuators 145 providing supplemental hydraulic lift. The SLD 108 combined with the lifting features of the LMD devices 106 and the frame beams 110 allow for direct lifting of wheels or the frame of small vehicles only requiring one ABLE device 100. The SLD is also particularly useful for mounting large vehicles requiring large clearance heights when lifted. The SLD 108 will be described later in greater detail.

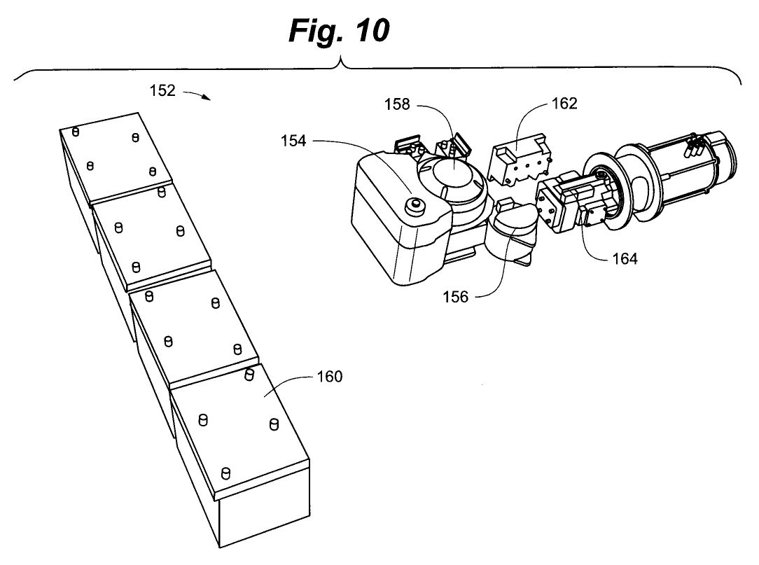

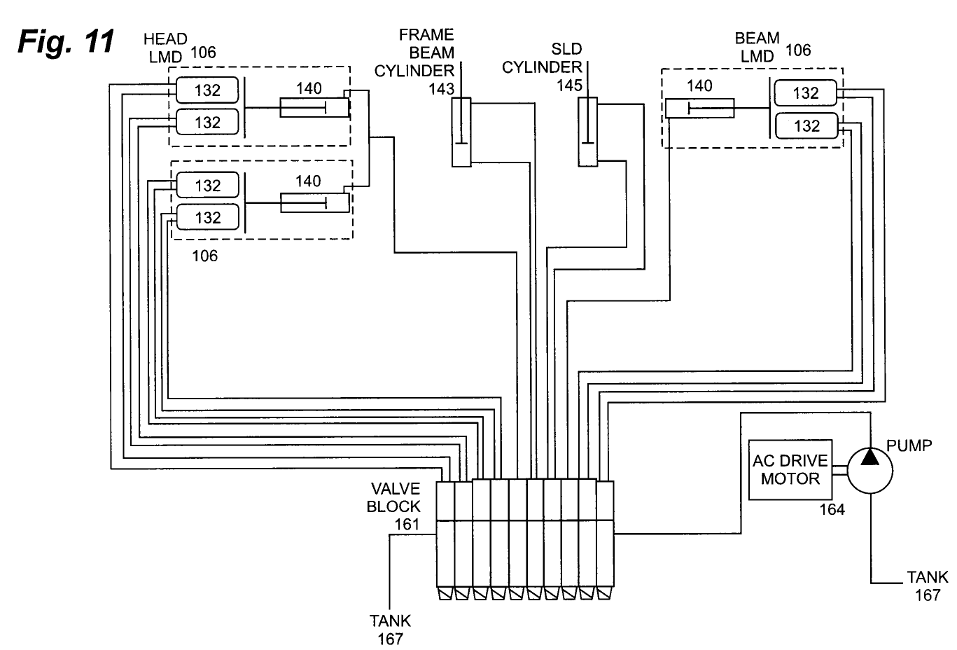

The general ABLE device 100 configuration allows for lifting of the undercarriage of tracked and large-wheeled vehicles. The lifting feature of the SLD 108 and the actuation of the frame beam 110 may also be achieved with a servo-controlled AC-powered electric-over-hydraulic system. Power for the ABLE devices 100 may be produced from a hybrid electrical system consisting of a diesel power generator 156, a Smart Bus Bar (SBB) 158, and standard maintenance-free battery banks 160 similar to those used in naval certified electric forklifts. This is set forth in FIGS. 10 and 11 and the related discussion which provides for more details regarding the electric hydraulic system of the ABLE device.

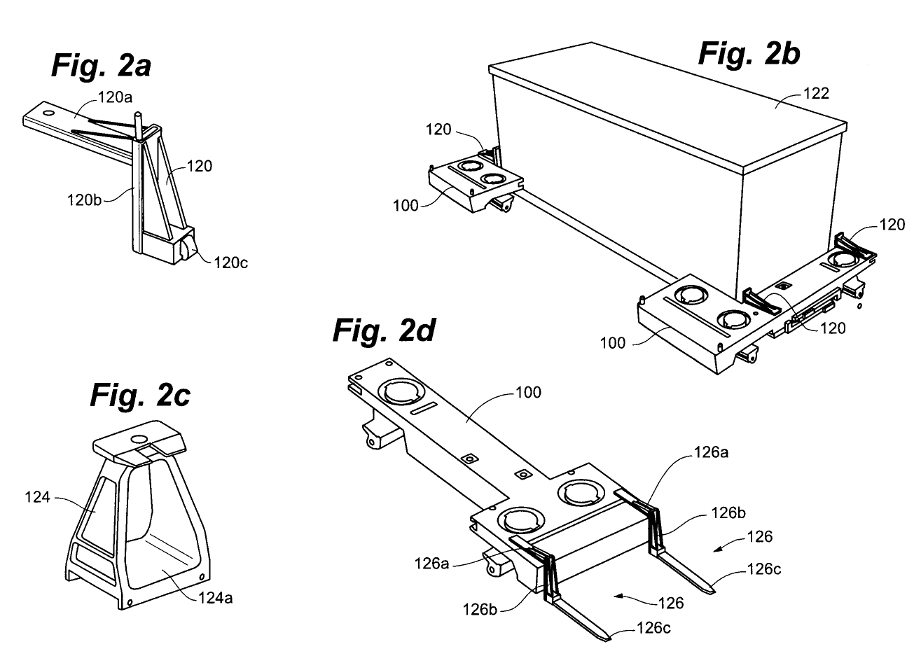

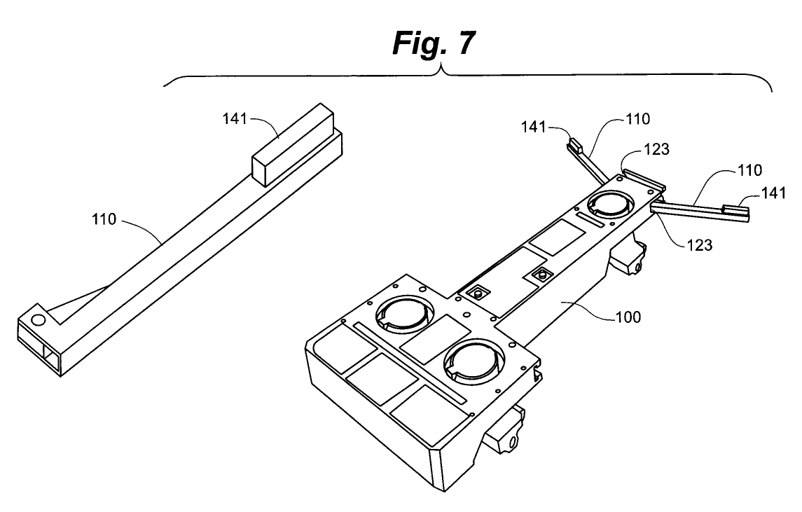

The ABLE devices 100 are designed to receive various adapters including beam adapters 120 that allow for handling of containers ranging from 20-foot ISO containers/Quadruple containers (QUADCONs) to a group of Joint Modular Intermodal Containers (JMICs). An example of such a beam adapter 120 is seen in FIG. 2a. The beam adapter generally includes a horizontally disposed member 120a and a vertically disposed member 120b which contains a container latch 120c. The horizontally disposed member 120a is adapted for engagement across the top surface 111b of beam section 102 and may be manually secured into place. The top of the vertically disposed member 120b is secured at a right angle with respect to the horizontally disposed member 120a. This arrangement allows the beam adapter 120 to hang below the surface 111b and provide an industry standard container latch 120c at this location. These beam adapters 120 and other adapters allow for continued growth of handling options thereby meeting the ever-changing needs of the warfighter. FIG. 2b shows use of adapters 120 on two ABLE devices 100 engaged in lifting a container 122. Note that the frame beams 110 may also be considered adapters which are useful to a number of lifting applications, as seen in FIG. 7.

Other possible adapters include a goose neck hitch 124, as seen in FIG. 2c, and fork tines 126, as seen mounted to an ABLE device in FIG. 2d. The goose neck hitch 124 comprises a large metal bracket with central channel 124a enabling towing of large military trailers or the like. Such a gooseneck hitch 124 could readily mount to the surface 111b of the beam portion 102 of the ABLE device 100, thereby allowing a variety of towing and lifting operations to be possible. The fork tine adapters 126 are designed for attachment to the head of the device, as seen in FIG. 2d. The fork tine adapters 126 having a horizontally disposed member 126a which is attached to the surface 111a of head member 101 as well as vertically disposed section 126b joining the horizontally disposed section 126a to the tines 126c that are used as a forklift in conjunction with the lifting capabilities of the ABLE device 100.

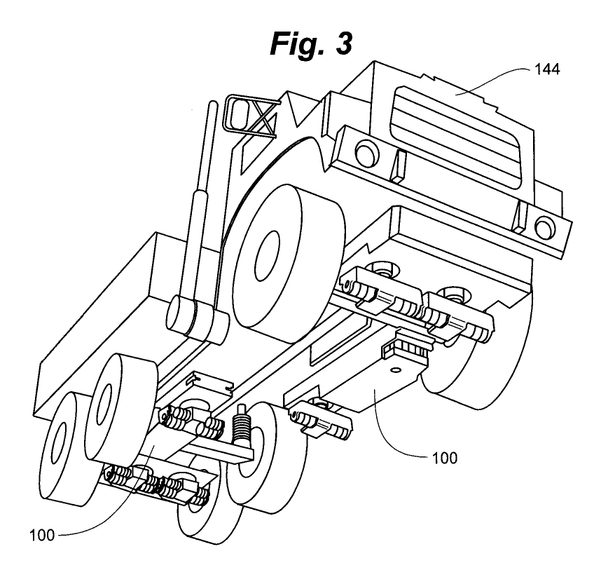

The lifting arrangement of FIG. 3 demonstrates an example of how multiple ABLE devices 100 are capable of being utilized together to form a system to lift and transport a wide range of vehicles and containers, such as the MVTR 144 that is depicted. In this example, two able devices 100 have been front loaded to lift the MVTR 144. Due to the configurability of the ABLE geometry and the flexibility to use multiple ABLE devices, most common military vehicles can be lifted with an ABLE device.

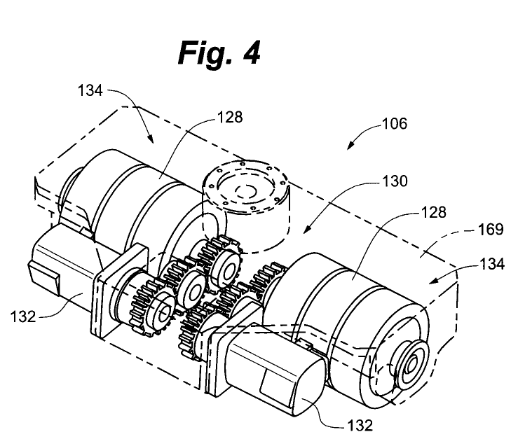

The LMD devices 106 implemented in the ABLE devices 100 contain a variety of features that provide desired maneuverability and control of operation including omni-directional movement. In some embodiments, the LMD devices 106 contain conventional wheels 128 for this movement. This wheel arrangement can be seen in the partial perspective view of FIG. 4 which sets forth the lower half of an LMD device. Note that the drive wheel quantity and size is load specific. To achieve omni-directional aspects, the design uses an Active Split Caster (ASC) 130. In general, sets of multiple wheels 134 are axially aligned in a caster housing 169 such that their axis is in the same plane as the pivoting axis of the casters located above their location in the LMD. Each set of wheels 134 is joined by a drive axle 170 to a gear train 171 which is driven by a hydraulic drive motor 132. The ACS 130 uses two common drive motors 132 controlled independently by the system controller. The drive motors drive wheel sets 134 on either side of a pivoting axis allowing for a variety of directional movement and control. More specifically, omni-directional control is achieved by varying the velocities of each drive. The imbalance in drive velocities of opposite wheel sets 134 allows for precise turning and steering capabilities. As the axis for rotation for these devices is in the same plane as the drive axis, little or no wheel slippage or skidding should result.

The LMD device arrangement using an ASC 130 has advantages which include a small space requirement and the mitigation of deck scrubbing during turning. The small vertical space required by LMD devices 106 implementing the ASC 130 creates a low-profile system, allowing the ABLE devices 100 to travel beneath the frames of the vehicles. Another advantage of this particular wheel arrangement concerns the effect of the roller-deck frictional loads during turning or omni-directional movements. This effect, called scrubbing, has many detrimental effects that include excessive roller wear, potential damage to the deck surface and high power/torque requirements, all of which are mitigated with the LMD device 106 design. Some embodiments may preferably use eight inch diameter wheels for the LMD devices 106 consisting of 90 A durometer polyurethane and a four inch steel core. Such a design will help provide characteristics to limit wear, improve friction to reduce slippage, and increase contact area to decrease contact pressure.

The location of the wheel sets 134 and their drive components are designed to work well with the shape of the ABLE structure. Specifically, the LMD devices 106 located in the head 101 of the device are spaced such that the wheel sets 134 do not extend beyond the perimeter of the space covered by the head structure. By arranging the wheels 134 such that they can fully rotate below the platform lifting structure and no difficulties will be experienced due to contact with overhanging wheels or parts from a lifted vehicle or container. This is true as the clearance provided should generally allow for an open space for a full range of wheel rotation and movement. Although the LMD device 106 located on the beam 102 has wheels that extend beyond the perimeter of the beam, the central location, low profile and use of the centrally configured “T” shaped device should allow for minimal issues of restricted or damaging movement due to wheel interference.

Alternatively, in some other embodiments it may be possible to alternatively adapt a system in which specialized wheels are built to achieve omni-directional movement rather than the conventional wheel design described. Such wheels would use a method of traction in one direction while allowing free motion in another. These types of wheels could include a number of arrangements, examples being a Mecanum wheel design or an orthogonal wheel.

In various embodiments it is preferable to use a lifting method which allows for concentration of lift on the frame of the vehicle when dealing with small wheeled vehicles. In various embodiments, a single ABLE device 100 is able to solely handle small wheeled vehicles, including the HMMWV (High-Mobility Multipurpose Wheeled Vehicle). This independent working ability allows for efficient use of ABLE devices 100 and fast load and unload times.

Various shapes for the overall geometry of the ABLE device are contemplated such an “I”, “T”, “C”, triangle, or rectangle shapes. The “T” and “L” arrangement shown in FIGS. 1a-f is particularly advantageous due to its adaptability, vehicle stability, simplicity, and increased packaging volume for components.

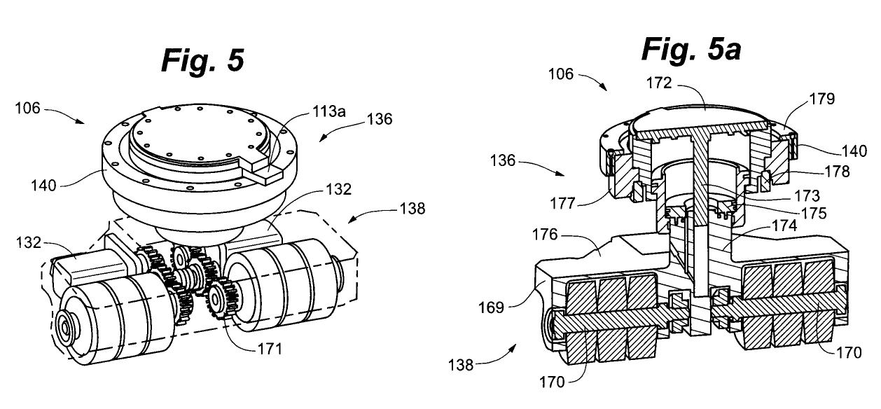

The LMD device 106 also incorporates hydraulic lift in the upper half of the device 136, while the lower half 138 of the LMD 106 generally is responsible for omni-directional control and general locomotion. The upper both upper and lower portions of a LMD device 106 can be seen in FIG. 5 and the cross-sectional view of the LMD device in FIG. 5a. The hydraulic lift includes a top cover 172 having an upper circular plate and which has a centrally located spline 173 on the lower half of the plate. This spline 173 extends into an interface feature 174 the caster housing 169 which is surrounded by a seal cap plate 175 Adjacent the interface feature 174 of the caster housing 169 is a pressure equalization path 176 to enable proper hydraulic operation of the lift. Additionally seen in FIG. 5a is a pivot bearing 177 surrounding the lift cylinder as well a bearing 178 set to the cylinder and a bearing 179 set to the frame. In all the telescopic cylinder contains three sections including the caster housing 169.

The upper half 136 of the LMD device 106 provides the lifting means for the small-wheeled vehicles, trailers, and containers. This is achieved via a hydraulic-operated telescopic lift cylinder and mast 140. In various embodiments, the LMD device 106 provides more than six inches of total travel while still allowing full omni-directional control. In general, the lift assembly of the LMD device 106 is compact and allows for easy transition of the ABLE device 100 under vehicles.

In conjunction with the LMD 106 to allow the lifting of small-wheeled vehicles and trailers, a removable remote fold-out frame interface may be used. This is referred to as a frame beam 110 and allows one ABLE device 100 to perform a lift of small-wheeled vehicles while still maintaining stability and load control. FIG. 7 shows the frame beam 110 rack-and pinion fold out system, allowing for remote placement and positioning of the beams under the frame of a vehicle. As previously mentioned, the frame beams 110 may be selectively mounted within the receptacles 123 located at the comers of the beam member 102. The frame beams 110 are mounted into by manually pinning these members into place. Once pinned in place, these members may be hydraulically controlled by an assembly in which auxiliary beam cylinders 143 are actuated at the frame beam mount locations. As such, a wide range of vehicles and containers can be readily adapted to with these beam members 102. Pads 141 located on the outwardly extending ends of each of the beam members help to provide generally non-abrasive contact surfaces for engaging vehicles or containers as well.

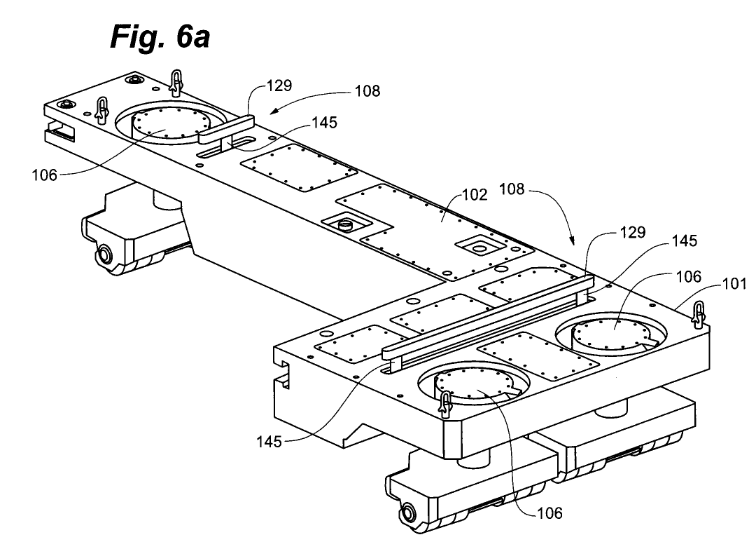

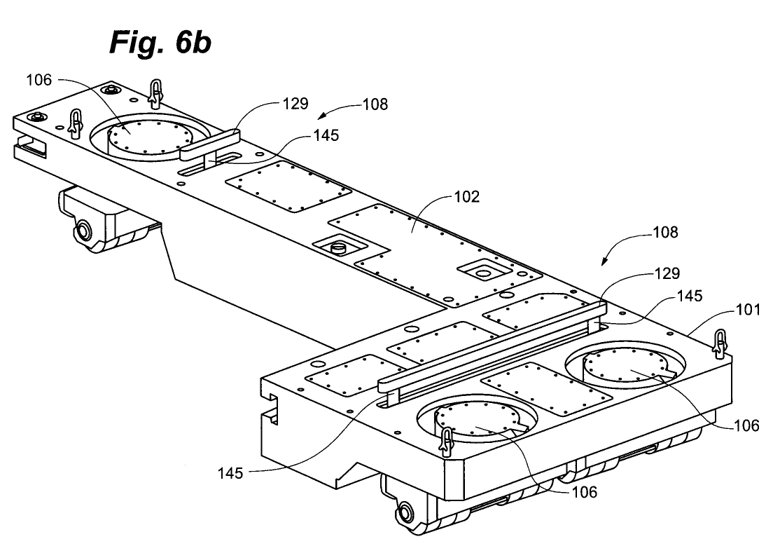

Another feature that may be present in various embodiments is the secondary lifting device (SLD) 108 that is shown in FIGS. 6a and 6b. These features allow for handling large wheeled and tracked vehicles that require unique or longer lifts. As seen in FIG. 1a, the SLD 108 may contain a first SLD member 125 located in the head portion 101 of an ABLE device, as well as a second SLD member 127 located in the beam portion 102 of the device. The SLD 108 locations each contain an elongate steel beam member 129 which may be raised and lowered from its respective location in the housing of either the head portion or beam portion of the ABLE device 100. The beams 129 are used for lifting and are mounted on hydraulic actuators such as hydraulic cylinders 145 which enable such supplemental raising and lowering to take place. Examples of lift beams 129 lifted into their extended lift configuration are seen in FIGS. 6a and 6b. This SLD 108 operation may occur as in FIG. 6a where the LMD devices 106 are in an extended lift position or, as in FIG. 6b, where the LMD devices are in a non-extended lift position.

When in the retracted state the beams 129 and their hydraulic lift cylinders 145 are entirely contained below the surfaces 111a and 111b of the beam 102 and head 101 portions of the frame in either the head housing compartment 117 or the beam housing compartment 119. Typically the SLD 108 is used to provide further lift of an especially large vehicle or vehicle with suspension requiring a large amount of ground clearance for unrestricted movement. Therefore, the SLD beams 129 are generally raised after the LMD devices 106 have already lifted the vehicle frame or container and further lift height of the object is desired. Accordingly, the SLD 108 allows lift of an object to a height above the ABLE frame that could not otherwise be reached without the secondary set of lifts. Commands to utilize the SLD 108 are communicated by an operator to the controller as is done in other ABLE operations.

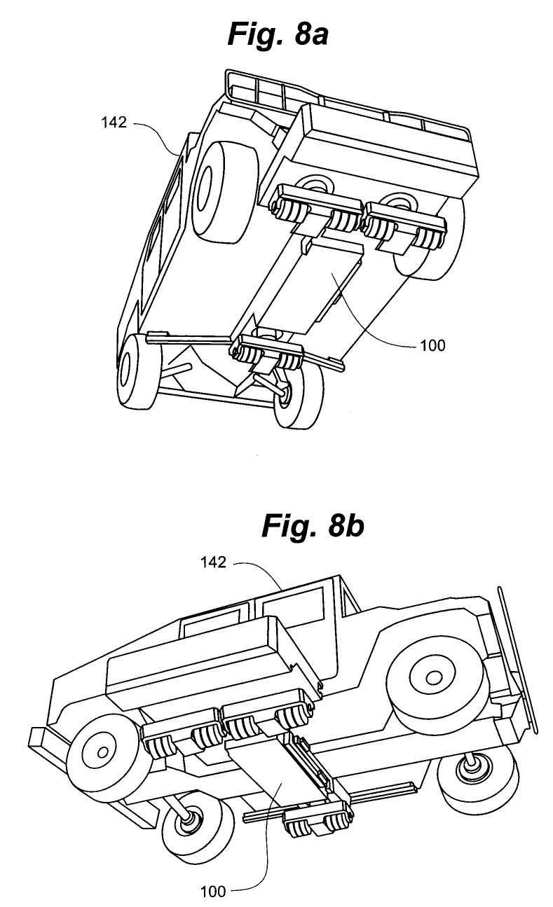

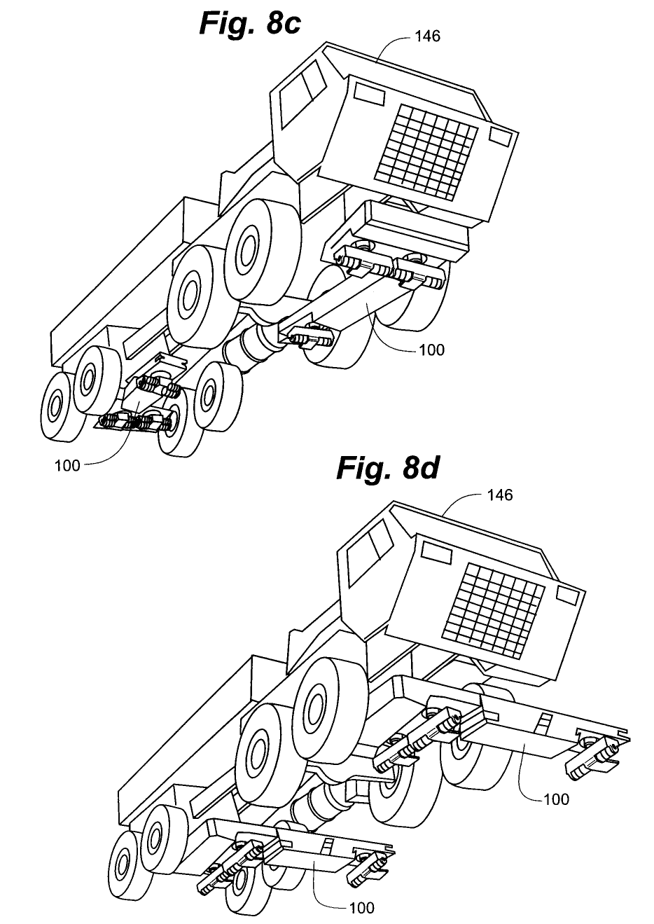

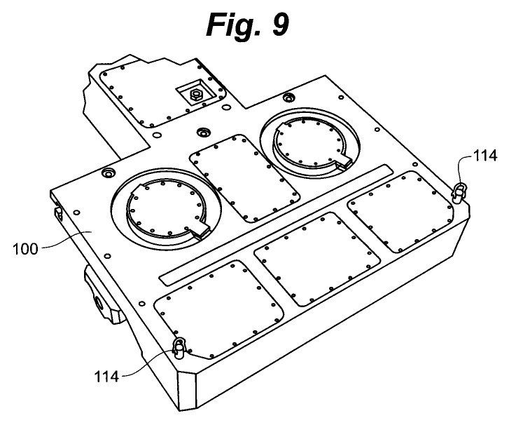

Various lifting arrangements are possible for the one or more ABLE devices 100 used in a system for a given vehicle or container. For example, such vehicles and containers may include an HMMWV 142, MTVR 144, Logistics Vehicle System Replacement (LVSR) 146, Bradley, ISO containers 122, or other object. Possible lifting arrangements for some of these vehicles are disclosed in FIGS. 2b, 3, and 8a-d. For most vehicles, the ABLE devices may be with either end-loaded or side loaded on vehicles, based on the needs and or space restrictions of the operator. As shown, the ABLE system is adaptable to vehicles of a wide range of types and sizes. Note that the devices may typically be designed to favor lifting the frames of vehicles rather than the tires. Generally greater versatility and adaptability is provided with such a design as the tires of vehicles tend to vary somewhat in location and number.

In embodiments of the invention, the ABLE system is designed for safe operations on sloped or moving decks and to thereby provide stability under sea conditions and the ability to prevent loss of load. Stability of the ABLE system is inherent in the design as it is adaptable and low. Lifting arrangements or configurations may be set to achieve the best stability based on vehicle geometry and position of the ABLE devices 100. Proper placement of the ABLE devices and lift points may be standardized per vehicle in handbooks and manuals as required.

The ABLE system maintains a low Center of Gravity of the vehicles lifted. During lifting, the vehicles are only lifted just beyond that of vehicle contact with the deck. This conserves power and allows for a stable lift, maintaining a low system center of gravity of the unit with the load. The frame beams 110 ensure proper frame captivation of smaller wheeled vehicles for better stability during movement and ship motion as well.

Preventing motion of the devices is achieved by locking the flow to the drive motors 132. This is accomplished with closed center hydraulic valves. Significant advantages of this method include that braking does not rely on friction so it is not susceptible to wear or heat, it is not effected by vibration, the reaction times are lower, and there is no free-wheeling during load moves leading to loss of control. Redundancy is designed within the system with emergency check valves that lock the flow in case of primary valve failure.

The prevention of load loss is achieved by safety chains that extend from a removable shackle 114 on the ABLE 100 to the vehicle shackle or lifting provision. The ABLE devices 100 have multiple mount locations for the quick release shackle 114 found about the perimeter of the device. Therefore, the device is adaptable to multiple vehicles and materials that it may handle. An embodiment disclosing the quick release shackle 114 is seen in FIG. 9. These shackles 114 may be utilized during sip transport, for example, when shifting forces could be experienced by the device.

The ABLE system 100 contains a power system that provides the availability for a complete ship onload or offload. In some embodiments, the power system may be a hybrid electrical system 152 that allows for optimal availability, thereby reducing the total number of systems required for a complete onload or offload. Such a hybrid system additionally has advantages in terms of cost and overall operating weight of the system. The components of hybrid electrical system are seen in FIG. 10 and described below. Note that in other embodiments, however, a device is alternatively contemplated that would be solely electrically controlled rather than the hybrid arrangement largely described in this disclosure.

In an hybrid electric hydraulic embodiment, a diesel or gas engine 154 drives a high-power alternator/generator 156 that feeds into the SBB (Smart Bus Bar) 158. The SBB 158 is connected to both the power output of the generator, battery bank 160, and the inverter 162. Any power not used by the generator is properly controlled and sent to the battery bank 160. The SBB 158 also monitors the battery condition and determines when the engine 154 should run. The batteries 160 are an Absorbed Glass Mat (AGM) type not requiring watering or any other maintenance. For example, the UN 2800 class non-spillable type of battery is approved for air and sea and provides a useful option for power storage in the ABLE system. Power from the SBB 158 goes to a high-power inverter 162 to control an AC hydraulic pump motor 164. The system uses an AC pump motor versus DC for better efficiencies under load, reduced heat rejection, maintenance and weight. Note that an electrical connection is made possible between the head 101 and beam 102 portions. Specifically, this connection is made through the keyed interface made at grooved feature 103 between the members via a wide slot cut into the key and the keyway. Therefore, a electrical connection point is established between the head 101 and beam 102 members of the frame.

Typically, in ABLE devices the engine 154, high power alternator 156, SBB 158, generator, inverter 162 hydraulic pump motor 164 will be located in the beam housing compartment 119. The batteries 160, valve blocks 161, and controller are located in the head housing compartment 117. In general, commands for movement, lift and operation are sent to the controller from an operator having a user interface enabling him or her to send commands via an IR, tethered, wired, or radio command. A variety of well-known hardware and software (i.e. antennas, transceivers, wireless networks, etc.) to accomplish the desired wired or wireless communication may be readily implemented as required. Software located on the controller 163 is able to process these commands and provide instructions to the hybrid electric and hydraulic system to coordinate movement, lift and general system operations.

A schematic of the hydraulic system and components which constitute an embodiment of this invention is disclosed in FIG. 11. As seen in this figure, hydraulic fluid for the ABLE system is supplied by a reservoir tank 167 located in the beam housing compartment 119. The hydraulic fluid is supplied from the tank 167 to a valve network comprised of a plurality of hydraulic hoses, valves, and sensors. This is done via an AC hydraulic pump motor 164, which pumps fluid to the valve block 161. From the valve block 161 hydraulic fluid and power may be selectively provided to the various hydraulic components in the ABLE system. Power is provided to hydraulic drive motors 132 of each of the LMDs located in the head 101 and beam 102 of the device as well as the lift cylinders 140 of the LMDs. Hydraulic power is also provided from valve block 161 to each of the SLD cylinders 145 needed to raise the SLD devices 108. Further, pressurized hydraulic fluid is provided to the cylinder 143 in the beam receptacles 123 to provide power for frame beam 110 movement. Instructions for this system provided by the controller which is equipped to receive input communications from the operator.

A feature of operation of the ABLE system includes using multiple ABLE devices 100 in cooperation with one another. This is accomplished when a plurality of ABLE devices are ganged and slaved (only logically not physically) together to form a system to lift and transport a wide range of vehicles and containers. Although, the operator of the ABLE system controls only one ABLE at a time, multiple units can be utilized. In general, the system is accomplished with a communications link via infared (IR) or tether between what is known as the master ABLE unit and the ABLE-(1-n) slave(s).

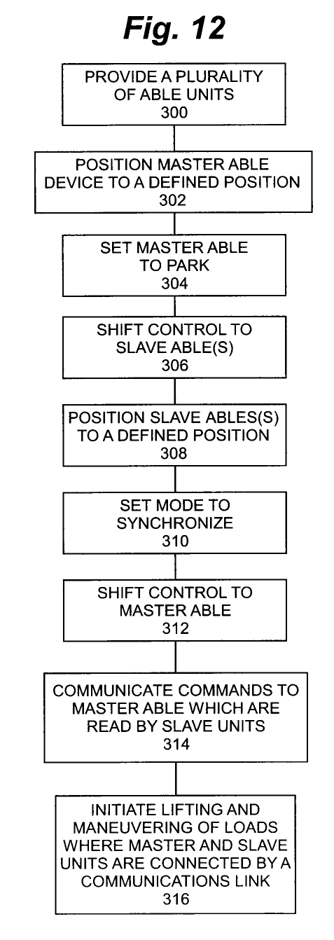

Specifically, steps to form such a system are set forth in the flowchart of FIG. 12. First, the multiple ABLE devices are provided including a master unit and one or more slave units which are each capable of independent drive, lift and maneuvering at 300. Next, the operator positions one ABLE, known as the master to a defined position aligned to engage a load consisting of a vehicle or container as set forth at 302. The operator next sets the master ABLE mode to park as at 304, and shifts the control to a second slave ABLE known as ABLE-1 as at 306. The operator can position the ABLE-1 to a defined position at 308 and repeat for any additional slave ABLE-n(s). Next, the operator set the mode of each of the slaves ABLE-1 to synchronize at 310. Next, the operator shifts control back to the master ABLE at 312. A system is now formed to lift, transport, and move vehicles or containers. At this point, the operator communicates commands to the system at 314 where each operator input to the system is to the master ABLE. This causes all slaved ABLE-n(s) to read the master ABLE for speed, LMD pivot location, LMD lift height, and SLD lift height. In some embodiments, up to three ABLE-n slaves can be added to form a given system. Finally, the operator initiates lifting and maneuvering of the desired loads at 316 using both the slave and master units in cooperation where commands from the operator are only directly communicated to the mater unit, which accordingly causes cooperative movement instructions to be given to the slave units via a communications link between the master and slave units.

Each ABLE 100 has redundancy in sensors and communication links. For example, this could be partially employed with a wireless or RF communication system utilizing structures such as an antenna 180. Also, each ABLE 100 has software monitoring load and speed limits and spikes. Combined with power-off brakes via check and closed center valves, the system can operate without the possibility of runaway. To further implement operational safety, each unit will not release brakes or latches unit until communications with master or operator is established and the signal is of specified strength.

It is envisioned that at least two classes of ABLEs would be utilized, a light class known as A-class and a heavy class of ABLE known as B-class. The A-class ABLE will serve the majority of the wheeled and tracked vehicles, QUADCONs, ganged or grouped JMICs, and trailers, both single and double axles all weighing under 56,000 pounds. The B-class ABLE will serve the majority of the wheeled and tracked vehicles, 20-foot ISO containers, and trailers, both single and double axles all weighing less than 144,000 pounds.

The ABLE devices 100 may weigh approximately 6000 lbm in some embodiments and are designed to interface with ship ramps and traction bars. Embodiments of the ABLE design are advantageous as they may have AC drives, do not require cleaning and brush replacement and adjustment, utilize AGM sealed batteries, and use a drive system design requiring little maintenance.

The ABLE system is designed to have one operator that can safely control one load at a time. In some embodiments, it is expected that for every four ABLE devices used, there would be two operators and one rigger. The rigger generally unlashes/lashes the vehicles and containers from the deck, safety chains the load to the ABLE, and acts as a safety observer.

The above summary of the invention is not intended to describe each illustrated embodiment or every implementation of the present invention. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

1. An adaptable beam lifter element device for lifting and maneuvering vehicles and containers, comprising:
a frame including a first elongate support portion and a second elongate support portion coupled adjacent one another in slideable relation;
a hybrid electric drive system disposed within the frame, the hybrid electric drive system including an engine coupled to a generator for charging a plurality of batteries;
an electric hydraulic assembly powered by said generator comprising a pump, a valve network, a plurality of telescopic lift cylinders, and a plurality of drive motors;
a controller for controlling operation of said engine, and said electric hydraulic assembly; and
a plurality of omni-directional drive devices located at spaced-apart locations on said frame, each of said omni-directional drive devices equipped with a telescopic lift cylinder and a pair of drive motors operably connected to a plurality of wheel units, said wheel units arranged in a split castor configuration, said omni-directional drive extending the frame from the wheel units.

2. The adaptable beam lifter element device of claim 1, further including a secondary lift device supported by said frame comprising a support bar coupled to a set of hydraulic actuators, said support bar extending above the frame.

3. The adaptable beam lifter element device of claim 1, wherein the device is adapted to be logically ganged and slaved to a second adaptable beam lifter element device.

4. The adaptable beam lifter element device of claim 1, wherein the device includes hydraulically controlled beam arms attached to said frame, said beam arms extending in the horizontal plane of the frame.

5. An adaptable beam lifter element device for lifting and maneuvering vehicles and containers, comprising:
a frame member having an upper face adapted to selectively interface with vehicles and containers of various shapes and dimensions;
a plurality of wheeled units disposed within the frame member wherein each unit includes a hydraulically actuated lift cylinder and a pair of hydraulic common drive motors capable of omni-directional maneuvering and drive, said lift cylinder positioned between a wheel set and the upper face of the frame member;
a secondary lift device supported by the frame member comprising a beam member coupled to a hydraulic lift cylinder, said secondary lift device arranged so that the beam member extends vertically from the upper face of the frame member;
a hydraulic beam arm pivotally attached at a first end to the frame member, said beam arm extending horizontally from the frame member; and
an electric-over-hydraulic system for providing control and hydraulic power for said plurality of wheeled units, said secondary lift device, and said beam arm.

6. The adaptable beam lifter element device of claim 5, wherein the adaptable beam lifter element device is adapted to be logically ganged and slaved to a second adaptable beam lifter element device.

7. The adaptable beam lifter element device of claim 5, wherein said frame member is comprised of a head unit and a beam unit, said head unit including a sliding engagement feature disposed on a margin that mates with a sliding engagement feature on the beam unit.

8. The adaptable beam lifter element device of claim 5, wherein the adaptable beam lifter element device additionally includes an auxiliary set of hydraulic actuators coupled to a kickstand to aid in lifting vehicles and containers, said kickstand disposed between the ground and the frame member.

9. An adaptable beam lifting system, comprising:
a master beam lifting unit comprising an adjustable frame including a hydraulically actuated lifting means and a hydraulically actuated drive means controlled by a electric hydraulic system;
a slave beam lifting unit comprising an adjustable frame including a hydraulically actuated lifting means and a hydraulically actuated drive means controlled by a electric hydraulic system, wherein the slave beam lifting unit is logically coupled to the master unit such that when operator input is made to the master unit, the slave unit reads the master unit for parameters including speed, pivot location, and lift heights.

10. The adaptable beam lifting system of claim 9, wherein the hydraulically actuated drive means of the master beam lifting unit and the slave beam lifting unit each contain a pair of common drive motors which are independently controlled and which utilize an active split castor system.

11. The adaptable beam lifting system of claim 10, wherein the hydraulically actuated lifting means of the master beam lifting unit and the slave beam lifting unit are telescopic hydraulic lift members.

12. The adaptable beam lifting system of claim 11, wherein additional slave beam lifting units are coupled to the master beam lifting unit.

13. The adaptable beam lifting system of claim 11, wherein additional slave beam lifting units are coupled to the master beam lifting unit by an infared communications link.

14. The adaptable beam lifting system of claim 11, wherein additional slave beam lifting units are coupled to the master beam lifting unit by a tethered communications link.

15. A method of lifting and transporting vehicles and containers, comprising:
providing a plurality of adaptable beam lifting element units including a master unit and one or more slave units, each of the adaptable beam lifting element units carrying out independent drive, lift and maneuvering;
positioning the master unit to a defined position aligned to engage a load consisting of a vehicle or container;
setting the master unit mode to park;
positioning said slave units one at a time to a position for engaging said load;
setting the slave unit mode to synchronize; and
communicating commands to the master unit which cause the slave units to read the master unit for speed, pivot locations and lift heights;
initiating lifting and maneuvering of said loads using both the slave and master units cooperatively where commands from the operator are only directly communicated to the master unit, the master unit thereafter causing cooperative movement instructions to be given to the slave units via a communications link between the master and the slave units.
